(19) United States
(12) Patent Application Publication
(10) Pub. No.: US 2013/0205994 A1
(43) Pub. Date: Aug. 15, 2013

(54) Piston For An Airless-Type Cosmetic Container

(71) Applicants: Mann-Soon Chang, Seoul (KR); Yun Gyu Park, Seoul (KR)

(72) Inventors: Mann-Soon Chang, Seoul (KR); Yun Gyu Park, Seoul (KR)

(21) Appl. No.: 13/808,572

(22) PCT Filed: May 12, 2011
(86) PCT No.: PCT/KR2011/003510

§ 371 Date: Jan. 29, 2013

(30) Foreign Application Priority Data
Jul. 9, 2010 (KR) 20-2010-0007271
May 4, 2011 (KR) 20-2011-0003836

(51) Int. Cl. F16J 1/00

(52) U.S. Cl. CPC F16J 1/00
USPC 92/172

(57) ABSTRACT

Disclosed herein is a piston for an airless-type cosmetic container. The piston disposed in the container is moved upwards by operation of an airless pump to discharge contents, and a silicone packing part is integrated with a piston main body along a periphery thereof using an insert molding method, thus improving productivity. In addition, instead of direct contact between the container and the piston, the silicone packing part surrounding the piston uniformly comes into close contact with the container, thus ensuring superior sealability between the piston and the container, regardless of the shape of the piston, thereby preventing the leakage of the contents and efficiently discharging the contents. Moreover, unlike typical cosmetic containers, the container can be implemented in various shapes, thereby maximizing marketability.

### TECHNICAL FIELD

The present invention relates to a piston for an airless-type cosmetic container, in which the piston disposed in the container is moved upwards by operation of an airless pump to discharge contents, and more particularly, to a piston for an airless-type cosmetic container, in which a silicone packing part is integrated with a piston main body along a periphery thereof using an insert molding method, thus improving productivity and in addition ensuring superior sealability between the piston and the container regardless of the shape of the piston, thereby preventing leakage of the contents and efficiently discharging the contents, and thus allowing the container to be implemented in various designs, thereby maximizing marketability.

### BACKGROUND ART

Generally, an airless-type cosmetic container is mainly used to store liquid- or gel-state cosmetics and discharge them in a uniform amount.

Such an airless-type cosmetic container includes a container that has a piston in an inner receiving portion thereof, a lower closure cap that is provided on a lower portion of the container, an airless pump that is coupled to an upper portion of the container and creates vacuum pressure in the container by a pushing operation to discharge a uniform amount of contents through a nozzle while the piston moves upwards, and an upper closure cap.

In such a conventional airless-type cosmetic container, the piston disposed in the inner receiving portion of the container is moved upwards by a pumping operation of the airless pump after the closure cap is removed from the container, thus discharging a uniform amount of contents.

However, the above-mentioned conventional airless-type cosmetic container is problematic in that it is very difficult to ensure the sealability of the piston.

That is, conventionally, the piston is formed of a synthetic resin material and is inserted into the container in such a way as to be in direct contact with the inner receiving portion thereof, so that it is impossible to attain superior contact ability between the piston and the inner receiving portion of the container, and consequently sealability is deteriorated.

In particular, if the piston is shaped such that a distance from a center to a periphery thereof is constant, as in a circular-type piston, force exerted by the inner receiving portion of the container is constant as a whole, so that it is possible to attain almost uniform contact force. However, if the piston does not have a circular structure but has various structures, e.g., a polygonal structure such as a triangular structure, a tetragonal structure, a pentagonal structure, a hexagonal structure, and an octagonal structure; an oval structure; a semicircular structure; and a freeform curved structure such that a distance from a center to a periphery thereof varies or a contact area with a corner is different from that with a side as in the polygonal structure, a different intensity of force is applied to an outer surface of the piston by the inner receiving portion of the container. Hence, the outer surface of the piston is bent or deformed, so that it is impossible to ensure uniform contact force and thereby sealability is reduced.

As such, if the sealability of the piston is reduced, the leakage of contents occurs, so that the contents are lost and vacuum pressure is not effectively created in the container. Consequently, the operation of discharging a uniform amount of contents by the upward movement of the piston is not smoothly performed.

Moreover, the conventional airless-type cosmetic container has limitations on implementing various shapes of designs as well as the circular shape, due to the sealability of the piston.

Therefore, the applicant of this invention has made efforts to develop technology to improve upon the piston structure of the conventional airless-type cosmetic container, thus implementing various designs in consideration of the function and design of the container.

### TECHNICAL PROBLEM

Accordingly, the present invention has been made keeping in mind the above problems occurring in the related art, and an object of the present invention is to provide a piston for an airless-type cosmetic container, in which a silicone packing part is integrated with a piston main body along a periphery thereof by an insert molding method, thus improving productivity and ensuring superior sealability between the piston and the container regardless of the shape of the piston, therefore preventing the leakage of contents and effectively discharging the contents.

Another object of the present invention is to provide a piston for an airless-type cosmetic container, which minimizes friction between the piston and the container when the piston moves upwards in the container, and maintains a good horizontal balance of the piston, thus improving the upward operability of the piston and allowing contents to be more effectively discharged.

A further object of the present invention is to provide a piston for an airless-type cosmetic container, which can ensure superior sealability between the piston and the container regardless of the shape of the piston, thus allowing the shape of the container to be selected from various structures, e.g., a polygonal structure such as a triangular structure, a tetragonal structure, a pentagonal structure, a hexagonal structure, and an octagonal structure; an oval structure; a semicircular structure; and a freeform curved structure, unlike typical cosmetic containers, and thereby increasing marketability.

### TECHNICAL SOLUTION

In an aspect, the present invention provides a piston for an airless-type cosmetic container intended to discharge contents when the piston inserted into a receiving portion defined in the container is moved upwards by an operation of an airless pump, wherein a silicone packing part is formed along a periphery of a main body of the piston in such a way as to protrude therefrom, and entirely and evenly comes into contact with an inner wall of the container receiving portion, thus ensuring sealability.

The silicone packing part may be integrated with the piston main body by an insert molding method.

At least one or more silicone packing parts may be formed on upper and lower portions of the periphery of the piston main body, with a rounded contact protrusion being formed along a periphery of each of the silicone packing parts in such a way as to protrude therefrom and resiliently coming into close contact with the container receiving portion.

The silicone packing part may include on upper and lower portions of the periphery thereof a main contact protrusion and a subsidiary contact protrusion, respectively, to ensure sealability between the silicone packing part and the container receiving portion and maintain a horizontal balance, the subsidiary contact protrusion including an opening so as to prevent vacuum from being created in a space defined between the main contact protrusion and the subsidiary contact protrusion.

The main body of the piston may have one structure of various structures, e.g., a polygonal structure such as a triangular structure, a tetragonal structure, a pentagonal structure, a hexagonal structure, and an octagonal structure; an oval structure; a semicircular structure; a clover structure; and a freeform curved structure in such a way as to correspond to the container receiving portion, the silicone packing part being coupled to the periphery of the piston main body, with a hollow portion being formed in the silicone packing part and a rounded contact protrusion being provided on an outer surface of the silicone packing part, whereby the silicone packing part entirely and evenly comes into close contact with the inner wall of the container receiving portion to ensure sealability.

The main body of the piston may have one structure of various structures, e.g., a polygonal structure such as a triangular structure, a tetragonal structure, a pentagonal structure, a hexagonal structure, and an octagonal structure; an oval structure; a semicircular structure; a clover structure; and a freeform curved structure in such a way as to correspond to the container receiving portion, the silicone packing part being integrated with the periphery of the piston main body by an insert molding method, with a rounded contact protrusion being provided on an outer surface of the silicone packing part, whereby the silicone packing part entirely and evenly comes into close contact with the inner wall of the container receiving portion to ensure sealability.

### ADVANTAGEOUS EFFECTS

As described above, the piston for the airless-type cosmetic container according to the present invention is manufactured so that a silicone packing part is integrated with a piston main body along a periphery thereof by an insert molding method, thus improving productivity and enabling the silicone packing part provided on a periphery of the piston to entirely and evenly come into close contact with the container, instead of a direct contact between the container and the piston, thereby ensuring superior sealability between the piston and the container regardless of the shape of the piston, therefore preventing the leakage of contents and effectively discharging the contents. Moreover, the present invention is advantageous in that the shape of the container can be implemented in various structures, e.g., a polygonal structure such as a triangular structure, a tetragonal structure, a pentagonal structure, a hexagonal structure, and an octagonal structure; an oval structure; a semicircular structure; and a freeform curved structure, unlike typical cosmetic containers, thus increasing marketability.

Further, the present invention is advantageous in that it can minimize friction between the piston and the container and maintain a good horizontal balance of the piston, when the piston moves upwards in the container, thus improving the upward operability of the piston and allowing contents to be more effectively discharged.

### DESCRIPTION OF DRAWINGS

FIG. 1 is a front sectional view showing an airless-type cosmetic container according to an embodiment of the present invention;

FIG. 2 is a front view showing an embodiment of the present invention;

FIG. 3 is a front view showing another embodiment of the present invention;

FIG. 4 is a front view showing a further embodiment of the present invention;

FIG. 5 is an enlarged view showing portion “A” encircled in FIG. 4;

FIG. 6 is a front view showing another embodiment of the present invention;

FIG. 7 is an enlarged view showing portion “B” encircled in FIG. 6;

FIG. 8 is a front view showing another embodiment of the present invention;

FIG. 9 is a perspective view of FIG. 8; and

FIGS. 10 to 18 are plan sectional views showing various embodiments of a container to which a piston of the present invention is applied.

### MODE FOR INVENTION

Hereinafter, the preferred embodiment of the present invention will be described in detail with reference to the accompanying drawings.

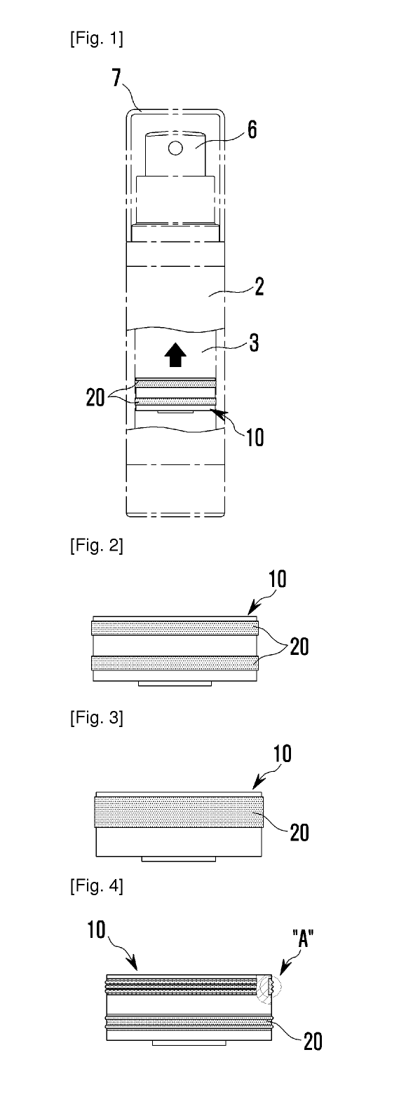

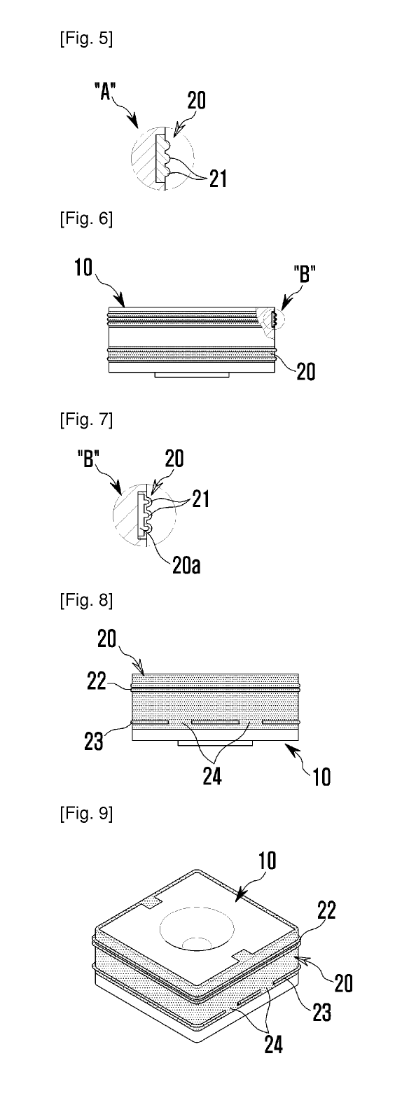

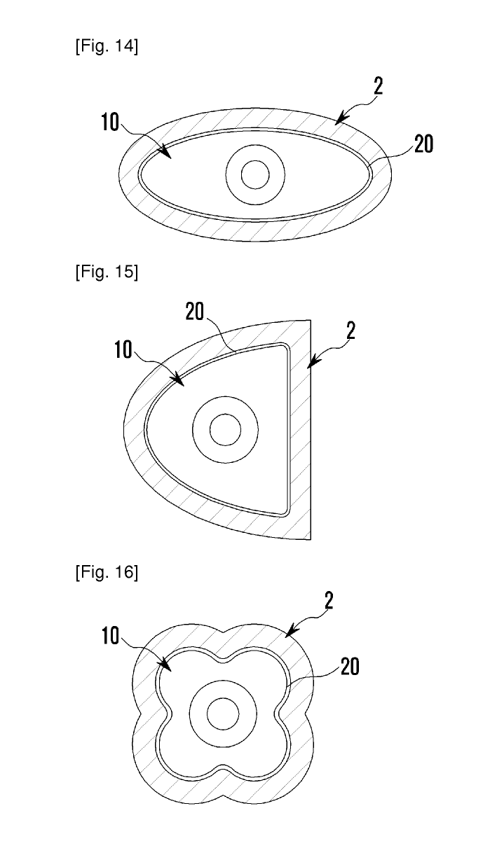

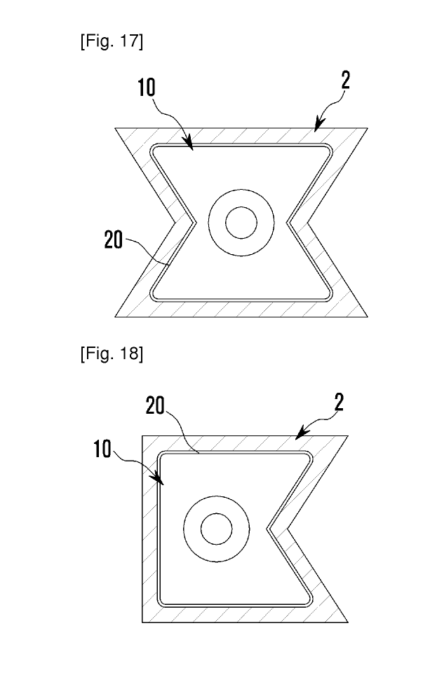

As shown in FIGS. 1 to 18, a piston for an airless-type cosmetic container according to the present invention is inserted into a receiving portion 3 defined in a container 2 and is moved upwards to discharge contents by the pushing operation of an airless pump 6. A silicone packing part 20 is formed along a periphery of the piston main body 10 in such a way as to protrude therefrom, so that the silicone packing part entirely and evenly comes into close contact with an inner wall of the container receiving portion 3 to ensure sealability between the piston and the container.

In particular, the silicone packing part 20 may be coupled to the periphery of the piston main body 10 in an O-ring form. However, the integration using an insert molding method is preferred.

In other words, the silicone packing part 20 is integrated with the periphery of the piston main body 10 by the insert molding method, so that the silicone packing part 20 can protrude evenly from the periphery of the piston regardless of the shape of the piston.

Further, as shown in FIGS. 2 and 3, a single silicone packing part 20 may be formed on the periphery of the piston main body 10, or at least one or more, a plurality of silicone packing parts may be formed on upper and lower portions thereof.

Moreover, in order to minimize frictional force between the silicone packing part 20 and the inner wall of the container receiving portion 3, a rounded contact protrusion 21 is formed along the periphery of the silicone packing part.

Further, in order to ensure superior sealability between the silicone packing part 20 and the inner wall of the container receiving portion 3 and good upward mobility, the silicone packing part is preferably made of silicone, rubber or a similar material.

According to such an embodiment of the present invention, the piston is manufactured so that a single or a plurality of silicone packing part or parts 20 is integrally formed on the upper and lower portions of the periphery of the piston main body 10 by the insert molding method, and then is inserted into the container receiving portion 3, thus attaining superior sealability with the container receiving portion 3.

That is, the silicone packing part 20 protrudes entirely and evenly from the periphery of the piston main body 10. Hence, unlike the prior art where the piston main body is in direct contact with the inner wall of the container receiving portion, almost constant force is exerted on the periphery of the piston main body and the silicone packing part 20 entirely and evenly comes into close contact with the inner wall of the container receiving portion 3, thus guaranteeing superior sealability.

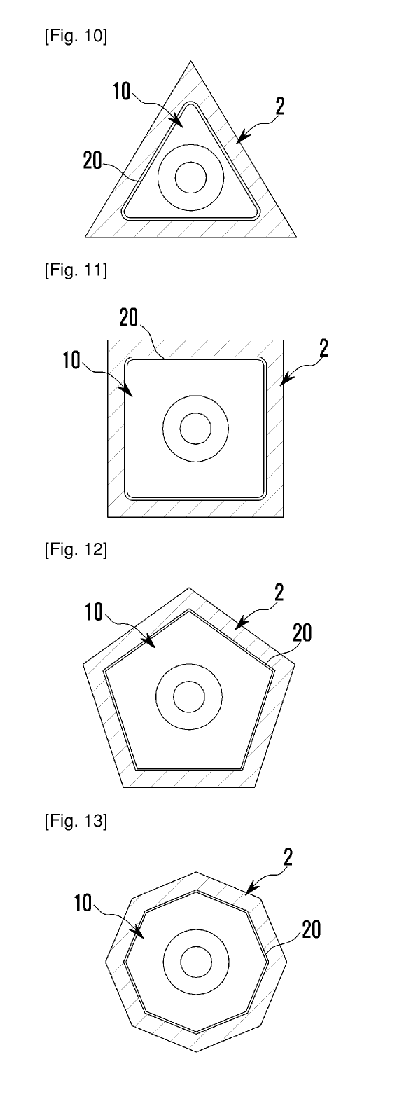

Further, the silicone packing part 20 protrudes entirely and evenly from the periphery of the piston main body 10. Therefore, even if the shape of the container is implemented, as shown FIGS. 10 to 18, in various structures, e.g., a polygonal structure such as a triangular structure, a tetragonal structure, a pentagonal structure, a hexagonal structure, and an octagonal structure; an oval structure; a semicircular structure; and a freeform curved structure, the silicone packing part 20 entirely and evenly comes into close contact with the inner wall of the container receiving portion 3, thus ensuring superior sealability.

As a result, it is possible to prevent contents from leaking downwards from the piston, and vacuum pressure created by an airless pump operation is increased to allow a uniform amount of contents to be effectively discharged.

Moreover, the silicone packing part 20 has the rounded contact protrusion 21 along the periphery thereof. Thus, sealability is ensured not by a surface contact but by a line contact between the silicone packing part and the inner wall of the container receiving portion 3, so that superior sealability is attained and frictional force is minimized, thus allowing the piston to more effectively move upwards, that is, allowing a uniform amount of contents to be more effectively discharged.

Meanwhile, the silicone packing part 20 of the present invention may be implemented as shown in FIGS. 8 and 9. This more specifically embodies the above-mentioned embodiment. In order to ensure sealability between the silicone packing part and the container receiving portion and maintain a horizontal balance, a main contact protrusion 22 and a subsidiary contact protrusion 23 are formed on upper and lower portions of the periphery of the silicone packing part 20 in such a way as to protrude therefrom. An opening 23a is formed in the subsidiary contact protrusion 23 to prevent vacuum from being created in a space 24 defined between the main contact protrusion and the subsidiary contact protrusion.

Here, the silicone packing part 20 may be formed separately from the main contact protrusion 22 and the subsidiary contact protrusion 23. However, it is preferable that the silicone packing part be integrated with the main contact protrusion and the subsidiary contact protrusion.

Such an embodiment of the present invention enables the silicone packing part 20 to entirely and evenly come into close contact with the inner wall of the container receiving portion by the main contact protrusion 22 and the subsidiary contact protrusion 23 that are provided, respectively, on the upper and lower portions of the silicone packing part, thus ensuring sealability.

Particularly, the main contact protrusion 22 located on the upper portion is mainly in close contact with the inner wall of the container receiving portion to ensure sealability, while the subsidiary contact protrusion 23 located on the lower portion ensures sealability and maintains a horizontal balance when the piston main body 10 moves upwards, thus affording the superior upward operation of the piston.

Therefore, the main contact protrusion 22 adopts a plurality of protrusions, whereas the subsidiary main contact protrusion 23 adopts a single protrusion.

Moreover, since the main contact protrusion 22 and the subsidiary contact protrusion 23 are provided on the upper and lower portions in such a way as to be spaced apart from each other, vacuum is created in the space 24 defined between the main contact protrusion and the subsidiary contact protrusion when the piston moves upwards, thus hindering the upward movement of the piston. However, the opening 23a formed in the subsidiary contact protrusion 23 prevents vacuum from being created, thus enabling the piston to effectively move upwards.

Further, the piston main body 10 of the present invention may be implemented as shown in FIGS. 4 to 7 and FIGS. 10 to 15. This makes the above embodiment more specific. The piston main body is formed to have one structure of various structures, e.g., a polygonal structure such as a triangular structure, a tetragonal structure, a pentagonal structure, a hexagonal structure, and an octagonal structure; an oval structure; a semicircular structure; and a freeform curved structure, in such a way as to correspond to the container receiving portion 3. The silicone packing parts 20 are coupled to the upper and lower portions of the piston main body 10 along the periphery thereof, with a hollow portion 20a being formed in each silicone packing part and the rounded contact protrusion 21 being provided on the outer surface of each silicone packing part. Alternatively, the silicone packing parts 20 each having on the outer surface thereof the rounded contact protrusion 21 are integrated with the upper and lower portions of the piston main body 10 along the periphery thereof by the insert molding method, thus ensuring sealability between the piston main body and the inner wall of the container receiving portion 3.

According to the embodiment of the present invention, the silicone packing part 20 having the hollow portion 20a therein and the rounded contact protrusion 21 on the outer surface thereof, or the silicone packing part having only the rounded contact protrusion 21 on the outer surface thereof is coupled to or integrated with each of the upper and lower portions of the piston main body 10 by the insert molding method, thus preventing the leakage of the contents, and affording the superior operation of discharging the contents and the superior upward movement of the piston, as described above.

In particular, the piston main body 10 and the inner receiving portion 3 of the container into which the piston main body is inserted may adopt one structure of various structures, e.g., a polygonal structure such as a triangular structure, a tetragonal structure, a pentagonal structure, a hexagonal structure, and an octagonal structure; an oval structure; a semicircular structure; and a freeform curved structure. This provides various shapes that cannot be implemented in the conventional cosmetic container, thus enhancing marketability.

Furthermore, as shown in FIGS. 16 to 18, the piston main body 10 of the present invention may be naturally formed in various shapes, such as a clover, “ [symbol] ”, “ [symbol] ”. In addition, it is noted that such a shape of the piston main body or a simple change in shape falls within the purview of the present invention.

1. A piston for an airless-type cosmetic container intended to discharge contents when the piston inserted into a receiving portion defined in the container is moved upwards by an operation of an airless pump,
wherein a silicone packing part is formed along a periphery of a main body of the piston in such a way as to protrude therefrom, and entirely and evenly comes into contact with an inner wall of the container receiving portion, thus ensuring sealability.

2. The piston according to claim 1, wherein the silicone packing part is integrated with the piston main body by an insert molding method.

3. The piston according to claim 1, wherein at least one or more silicone packing parts are formed on upper and lower portions of the periphery of the piston main body, with a rounded contact protrusion being formed along a periphery of each of the silicone packing parts in such a way as to protrude therefrom and resiliently coming into close contact with the container receiving portion.

4. The piston according to claim 1, wherein the silicone packing part comprises on upper and lower portions of the periphery thereof a main contact protrusion and a subsidiary contact protrusion, respectively, to ensure sealability between the silicone packing part and the container receiving portion and maintain a horizontal balance, the subsidiary contact protrusion including an opening so as to prevent vacuum from being created in a space defined between the main contact protrusion and the subsidiary contact protrusion.

5. The piston according to claim 1, wherein the main body of the piston has a shape to correspond to the container receiving portion, the silicone packing part being coupled to each of the upper and lower portions of the periphery of the piston main body, with a hollow portion being formed in the silicone packing part and a rounded contact protrusion being provided on an outer surface of the silicone packing part, whereby the silicone packing part entirely and evenly comes into close contact with the inner wall of the container receiving portion to ensure sealability.

6. The piston according to claim 1, wherein the main body of the piston has a shape to correspond to the container receiving portion, the silicone packing part being integrated with each of the upper and lower portions of the periphery of the piston main body by an insert molding method, with a rounded contact protrusion being provided on an outer surface of the silicone packing part, whereby the silicone packing part entirely and evenly comes into close contact with the inner wall of the container receiving portion to ensure sealability.

7. The piston according to claim 5, wherein the shape of the piston defines a structure selected from the group consisting of a polygonal structure, an oval structure, a semicircular structure, a clover structure, and a freeform curved structure.

8. The piston according to claim 7, wherein the polygonal structure is selected from the group consisting of a triangular structure, a tetragonal structure, a pentagonal structure, a hexagonal structure, and an octagonal structure.

9. The piston according to claim 6, wherein the shape of the piston defines a structure selected from the group consisting of a polygonal structure, an oval structure, a semicircular structure, a clover structure, and a freeform curved structure.

10. The piston according to claim 9, wherein the polygonal structure is selected from the group consisting of a triangular structure, a tetragonal structure, a pentagonal structure, a hexagonal structure, and an octagonal structure.

11. A piston assembly for a container that discharges contents when the piston is moved upwards in a receiving portion of the container, the receiving portion of the container having an inner wall, the piston assembly comprising:
a main body having a periphery; and
a silicone packing part formed along the periphery of the main body such a way as to protrude therefrom;
wherein the silicone packing part protrudes from the main body in such a way as to entirely and evenly come into contact with the inner wall of the receiving portion of the container to ensure sealability.

12. The piston assembly of claim 11, wherein the silicone packing part is integrally formed with the piston main body.

13. The piston assembly of claim 11, wherein at least one or more silicone packing parts are formed on upper and lower portions of the periphery of the piston main body, with a rounded contact protrusion being formed along a periphery of each of the silicone packing parts in such a way as to protrude therefrom, resiliently coming into close contact with the receiving portion of the container.

14. The piston assembly of claim 11, wherein the silicone packing part comprises on upper and lower portions of the periphery thereof a main contact protrusion and a subsidiary contact protrusion, respectively, to ensure sealability between the silicone packing part and the receiving portion of the container, and maintain a horizontal balance;
wherein the subsidiary contact protrusion includes an opening so as to prevent vacuum from being created in a space defined between the main contact protrusion and the subsidiary contact protrusion.

15. The piston assembly of claim 11, wherein the main body of the piston assembly is correspondingly shaped to correspond to the receiving portion of the container;
wherein the silicone packing part is coupled to each of upper and lower portions of the periphery of the main body, with a hollow portion being formed in the silicone packing part and a rounded contact protrusion being provided on an outer surface of the silicone packing part; and
wherein the silicone packing part entirely and evenly comes into close contact with the inner wall of the receiving portion of the container to ensure sealability.

16. The piston assembly of claim 11, wherein the main body of the piston assembly is correspondingly shaped to correspond to the receiving portion of the container;
wherein the silicone packing part is integrally formed with each of upper and lower portions of the periphery of the main body, with a rounded contact protrusion being provided on an outer surface of the silicone packing part; and
wherein the silicone packing part entirely and evenly comes into close contact with the inner wall of the receiving portion of the container to ensure sealability.
